(19) United States
(12) Patent Application Publication
(10) Pub. No.: US 2006/0038753 A1
(43) Pub. Date: Feb. 23, 2006

(54) Light emitting display driver and method thereof

(76) Inventors: Kyoung-Soo Lee, Suwon-si (KR); June-Young Song, Suwon-si (KR)

Correspondence Address: CHRISTIE, PARKER & HALE, LLP, PO BOX 7068, PASADENA, CA, 91109-7068, US

(21) Appl. No.: 11/185,636

(22) Filed: Jul. 19, 2005

(30) Foreign Application Priority Data
Aug. 20, 2004 (KR) 10-2004-0065775

(51) Int. Cl. G09G 3/30

(52) U.S. Cl. 345/76

(57) ABSTRACT

A display panel driver of a light emitting display having a main panel disposed on a front surface and a sub panel disposed on a rear surface. The display panel driver includes a main scan driver sequentially applying selection signals to a plurality of scan lines in the main panel along a first direction, a sub scan driver sequentially applying selection signals to a plurality of scan lines in the sub panel along an opposite direction of the first direction, and a drive controller respectively controlling scanning directions of the main scan driver and the sub scan driver.

### CROSS REFERENCE TO RELATED APPLICATION

This application claims priority to and the benefit of Korean Patent Application No. 10-2004-0065775 filed on Aug. 20, 2004 in the Korean Intellectual Property Office, the entire content of which is incorporated herein by reference.

### BACKGROUND OF THE INVENTION

1. Field of the Invention

The present invention relates to a panel driver of a light emitting display and a method thereof, and more particularly, it relates to a display panel driver for driving a main panel and a sub panel of an organic electroluminescent display and a method for driving the same.

2. Description of the Related Art

In general, according to an organic electroluminescent (EL) display device, phosphorus organic components are disposed into pixels arranged in a matrix format, and an image is visualized by controlling the amount of a current flowing to the phosphorus organic components. Such an organic EL display device is an advanced display having high responsiveness, low power consumption, and a wide view angle. Thus, the organic EL display is expected to be the next-generation display.

FIG. 1 schematically illustrates a light emission mechanism of an organic EL display (OLED). Typically, an OLED device electrically excites phosphorus organic components, and visualizes an image by voltage-programming or current-programming M×N numbers of organic light emitting cells. As shown in FIG. 1, these organic light emitting cells include an indium tin oxide (ITO) pixel electrode, an organic thin film 10, and a metal layer. The organic thin film 10 has a multi-layered structure including an emission layer, an electron transport layer (ELT), and a hole transport layer (HTL) so as to balance electrons and holes and thereby enhance efficiency of light emission. Further, the organic thin film 10 separately includes an electron injection layer (EIL) and a hole injection layer (HIL).

Methods of driving the organic light emitting cells having the foregoing configuration include a passive matrix method and an active matrix method, the active matrix method employing a thin film transistor (TFT). In the passive matrix method, an anode and a cathode are formed crossing each other and a line is selected to drive the organic light emitting cells. In the active matrix method, on the other hand, each indium tin oxide (ITO) pixel electrode is coupled to the TFT, and the light emitting cell is driven in accordance with a voltage maintained by capacitance of a capacitor coupled to a gate of the TFT.

Recently, a folder-type cellular phone has become popular, and OLEDs of different sizes are mounted on inner and external surfaces of the phone. In this case, the OLED mounted on the inner surface of the phone is usually larger than the OLED mounted on the external surface thereof. Such OLEDs having different sizes typically need to be controlled independently and need twice the number of parts than usual, thereby increasing manufacturing cost.

Further, emission directions of the main panel and the sub panel are reversed with respect to each other to concurrently realize the main panel and the sub panel in the OLED panel for a portable phone, and thus data displayed on the main panel is reversely displayed on the sub panel and the driving integrated circuit (IC) must reverse the data which is upside down.

### SUMMARY OF THE INVENTION

In accordance with the present invention there is provided a display panel driver of a light emitting display and a method for driving the same to control a main panel and a sub panel to normally display an image on both panels without inversion of display output data by setting scanning directions of a main panel scan driver and a sub panel scan driver to be opposite to each other when OLED panels are used on both sides of the display panel of the light emitting display.

In addition, the display panel driver of the light emitting display and the method for driving the same according to the present invention use a single driving IC respectively controlling the scanning direction of the main and sub panels without inversion of display output data.

In an embodiment of the present invention to a display panel driver of a light emitting display has a main panel disposed on a front surface and a sub panel disposed on a rear surface, the display panel driver having a main scan driver, a sub scan driver, and a drive controller. The main scan driver sequentially applies selection signals to a plurality of scan lines in the main panel along a first direction. The sub scan driver sequentially applies selection signals to a plurality of scan lines in the sub panel along an opposite direction of the first direction. The drive controller respectively controls scanning directions of the main scan driver and the sub scan driver.

In another embodiment of the present invention a light emitting display includes a main panel for a frontward display of the light emitting display, a sub panel for a rearward display of the light emitting display, a main scan driver, a sub scan driver, a data driver, and a drive controller. The main scan driver sequentially applies respective selection signals to a plurality of scan lines in the main panel along a first direction. The sub scan driver sequentially applies respective selection signals to a plurality of scan lines in the sub panel along an opposite direction of the first direction. The data driver applies data voltages to selected pixel circuits of the main panel and the sub panel, the data voltages corresponding to image signals. The drive controller respectively controls scanning directions of the main scan driver and the sub scan driver.

In yet another embodiment of the present invention a method is provided for driving a light emitting display having a main panel and a sub panel respectively for frontward and rearward display of the light emitting display. In the driving method, scanning directions of a main scan driver and a sub scan driver are set to be opposite to each other, selection signals are sequentially applied to a plurality of scan lines of the main panel, selection signals are sequentially applied to a plurality of scan lines of the sub panel, and a plurality of data voltages corresponding to image sigrials are sequentially applied to selected pixel circuits of the main and sub panels.

The main panel and the sub panel may share data lines applying the data voltages corresponding to the image signals.

The scanning direction of the main scan driver may be a direction from an upper portion to a lower portion of the main panel.

The scanning direction of the sub scan driver may be a direction from a lower portion to an upper portion of the sub panel.

### BRIEF DESCRIPTION OF THE DRAWINGS

FIG. 1 is a schematic depiction of an emission mechanism of an OLED.

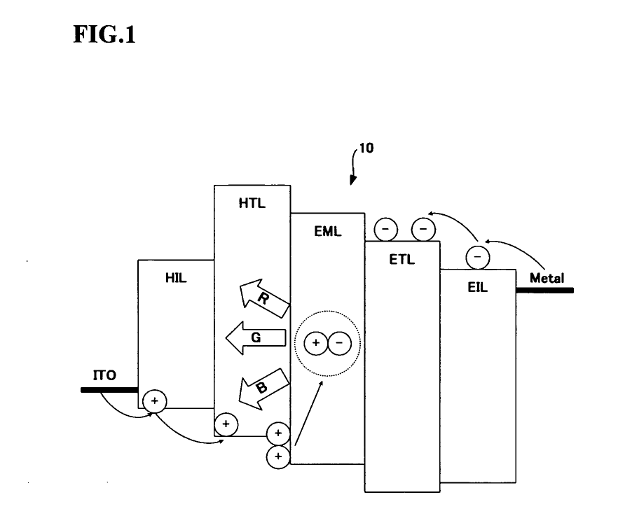

FIG. 2 is a schematic block diagram of an OLED according to an embodiment of the present invention.

FIG. 3 illustrates an OLED panel employing an active matrix method using a TFT.

FIG. 4A and FIG. 4B are external views of a main panel and a sub panel of a mobile phone having a light emitting display according to an embodiment of the present invention.

FIG. 5 schematically shows a configuration of the display panel driver of the light emitting display according to an embodiment of the present invention.

FIG. 6 illustrates emission of the main panel and the sub panel of the light emitting display according to an embodiment of the present invention.

### DETAILED DESCRIPTION

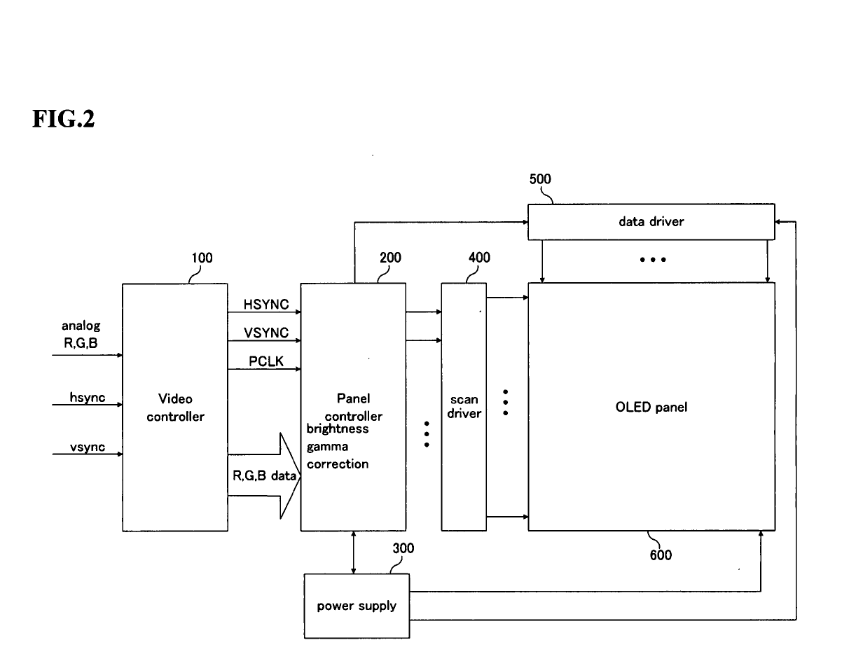

Referring now to FIG. 2, an OLED according to an embodiment of the present invention includes a video controller 100, a panel controller 200, a power supply 300, a scan driver 400, a data driver 500, and an OLED panel 600.

In the OLED various signals that have passed through an analog interface and a digital interface are applied to the OLED panel 600 in column and row directions by the scan driver 400 and the data driver 500, respectively.

In more detail, the various analog signals including red, green, and blue (RGB) signals, a vertical synchronization signal, and a horizontal synchronization signal are input to the video controller 100 so as to be converted into digital signals. The panel controller 200 that controls the converted digital signals sequentially supplies driver control signals to the scan driver 400 and the data driver 500. The OLED panel 600 displays an image by voltage-driving or current-driving n×m numbers of organic light emitting cells using power from the power supply 300 and signals from the scan driver 400 and the data driver 500.

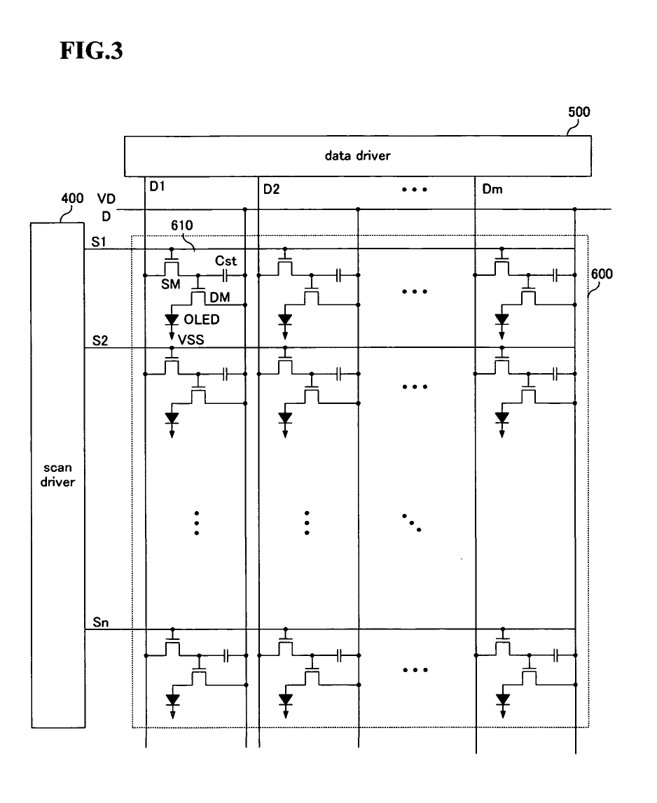

Referring now to FIG. 3, which illustrates an OLED panel employing an active matrix method using a TFT according to an embodiment of the present invention, the OLED shown includes an OLED panel 600, a scan driver 400, and a data driver 500.

The OLED panel 600 includes data lines D1 to Dm arranged in rows, scan lines S1 to Sn arranged in columns, and n×m numbers of pixel circuits. The data lines D1 to Dm transmit data signals as image signals to the pixel circuits, and the scan lines S1 to Sn transmit selection signals to the pixel circuits. Herein, a representative pixel circuit is formed on a single pixel area 610 defined by two adjacent data lines D1, D2 of the data lines D1 to Dm and two adjacent scan lines S1, S2 of the scan lines S1 to Sn.

The scan driver 400 sequentially applies the selection signals to the scan lines S1 to Sn, and the data driver 500 applies a data voltage corresponding to the image signal to the data lines D1 to Dm. The scan driver 400 and/or the data driver 500 may be electrically coupled to the OLED panel 600 in various schemes. For example, it may be realized in a form of a chip so as to be installed to various types of electrical connection members, such as a tape carrier package (TCP), a flexible printed circuit (FPC), and a film.

Alternatively, the scan driver 400 and/or the data driver 500 may be directly attached to a glass substrate of the display panel 600, and they may be realized as a driving circuit that is formed on a glass substrate and has a layer structure similar to scan lines, data lines, and the TFTs.

Further, the representative pixel circuit 610 includes an OLED, a switching transistor SM, a driving transistor DM, and a capacitor Cst. For example, the switching and driving transistors may be provided as a PMOS-type transistor.

A source of the driving transistor DM is coupled to a power voltage VDD, and the capacitor Cst is coupled between a gate and the source of the driving transistor DM. The capacitor Cst maintains a gate-source voltage of the driving transistor DM for a predetermined period of time, and the driving transistor DM outputs a current corresponding to the gate-source voltage maintained by the capacitor Cst, i.e., the voltage difference between the gate and the source of the driving transistor DM. The switching transistor SM transmits the data signal from the data line Dm to the driving transistor DM in response to the selection signal from the current scan line Sn.

A cathode of the OLED is coupled to a reference voltage Vss, and emits light corresponding to the current applied through the driving transistor DM. Herein, the reference voltage Vss coupled to the cathode of the OLED is lower than a power VDD, and for example, a ground voltage may be used for the reference voltage.

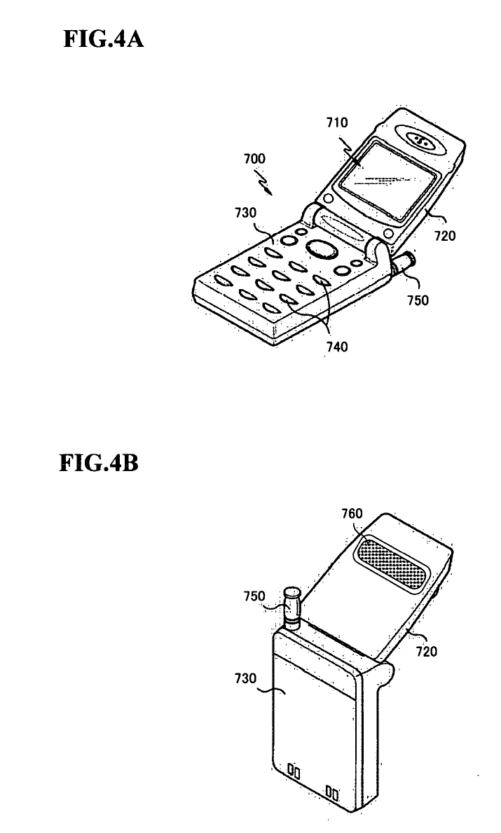

FIG. 4A and FIG. 4B respectively show an external view of a main panel 710 formed on a front surface and a sub panel 760 formed on a rear surface of a portable terminal (hereinafter referred to as a mobile phone) 700. The mobile phone 700 having the light emitting display according to an embodiment of the present invention includes a main panel 710, a folder 720, a keypad 740, a main body 730 of a dual-folder type mobile phone on which the keypad 740 is mounted, an antenna 750, and a sub panel 760.

When the main panel 710 and the sub panel 760 on the front and rear surfaces of the mobile phone 700 are simultaneously realized, a reversion of displayed data between the panels 710 and 760 may be prevented by driving the panels 710 and 760 according to opposite scanning directions.

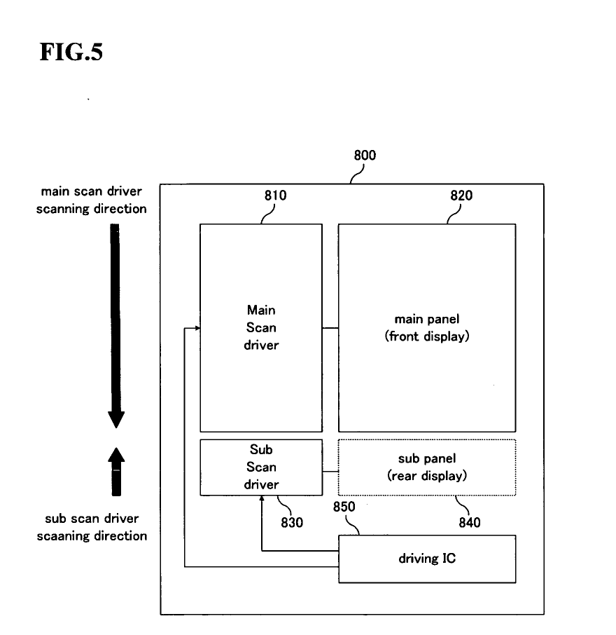

FIG. 5 shows a schematic configuration of the display panel driver according to an embodiment of the present invention. The display panel driver is realized in a display panel 800 including a main panel 820 and a sub panel 840.

A main scan driver 810 sequentially applies selection signals to a plurality of scan lines along a first direction, and a sub scan driver 830 sequentially applies the selection signals to the plurality of scan lines along an opposite direction of the first direction. For example, a scanning direction of the main scan driver 810 may be a direction from an upper portion to a lower portion of the main panel 820, and a scanning direction of the sub scan driver 830 may be a direction from a lower portion to an upper portion of the sub panel 840.

A driving IC respectively controls the scanning directions of the main and sub scan drivers 810 and 830. Further, the main panel 820 and the sub panel 840 share data lines that receive data voltages corresponding to image signals.

In a driving method of a display panel of the light emitting display according to the present invention, the scanning directions of the main scan driver and the sub scan driver are set to be opposite to each other, and the selection signals are sequentially applied to the respective scan lines and to the respective data lines. A plurality of data voltages respectively corresponding to the image signal are sequentially applied to selected pixel circuits of the main panel and the sub panel so that the main panel and the sub panel can respectively display an image.

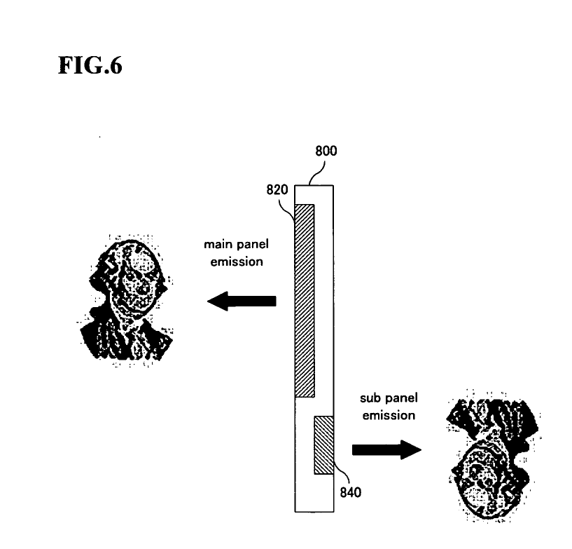

FIG. 6 illustrates emission of the main panel and the sub panel of the light emitting display according to the present invention. In a lateral view of the display panel 800, the main panel 820 normally displays an image and the sub panel 840 display the image upside down. However, the reversed image displayed on the sub panel 840 becomes normal when the folder is closed.

According to the present invention, when the main panel and the sub panel are synchronously realized on an OLED panel for a mobile phone, the scanning directions of the main panel and the sub panel are set to be opposite to each other. Therefore, an image is normally displayed on both panels without inversion of display output data.

Further, according to the present invention, a signal driving IC respectively controls the scanning directions of the main and sub scan drivers without inversion of display output data. Therefore, the driving IC can be readily designed.

While this invention has been described in connection with what is presently considered to be practical embodiments, it is to be understood that the invention is not limited to the disclosed embodiments, but, on the contrary, is intended to cover various modifications and equivalent arrangements included within the spirit and scope of the appended claims.

What is claimed is:

1. A display panel driver of a light emitting display having a main panel disposed on a front surface and a sub panel disposed on a rear surface, the display panel driver comprising:
a main scan driver sequentially applying selection signals to a plurality of scan lines in the main panel along a first direction;
a sub scan driver sequentially applying selection signals to a plurality of scan lines in the sub panel along an opposite direction of the first direction; and
a drive controller respectively controlling scanning directions of the main scan driver and the sub scan driver.

2. The display panel driver of claim 1, wherein the scanning direction of the main scan driver is a direction from an upper portion to a lower portion of the main panel.

3. The display panel driver of claim 1, wherein the scanning direction of the sub scan driver is a direction from a lower portion to an upper portion of the sub panel.

4. The display panel driver of claim 1, wherein the drive controller is realized in a single driving integrated circuit.

5. A light emitting display comprising:
a main panel for a frontward display of the light emitting display;
a sub panel for a rearward display of the light emitting display;
a main scan driver sequentially applying respective selection signals to a plurality of scan lines in the main panel along a first direction;
a sub scan driver sequentially applying respective selection signals to a plurality of scan lines in the sub panel along an opposite direction of the first direction;
a data driver applying a data voltage to selected pixel circuits of the main panel and the sub panel, the data voltage corresponding to an image signal; and
a drive controller respectively controlling scanning directions of the main scan driver and the sub scan driver.

6. The light emitting display of claim 5, wherein the main panel and the sub panel share a data line applying the data voltage corresponding to the image signal.

7. The light emitting display of claim 5, wherein the scanning direction of the main scan driver is a direction from an upper portion to a lower portion of the main panel.

8. The light emitting display of claim 5, wherein the scanning direction of the sub scan driver is a scanning direction from a lower portion to an upper portion of the sub panel.

9. A method for driving a light emitting display having a main panel and a sub panel respectively for frontward and rearward display of the light emitting display, the driving method comprising:
setting scanning directions of a main scan driver and a sub scan driver opposite to each other;
sequentially applying selection signals to a plurality of scan lines of the main panel;
sequentially applying selection signals to a plurality of scan lines of the sub panel; and
realizing displays of the main panel and the sub panel by sequentially applying a plurality of data voltage corresponding to an image signal to selected pixel circuits of the main panel and the sub panel.

10. The driving method of claim 9, wherein the scanning direction of the main scan driver is a direction from an upper portion to a lower portion of the main panel.

11. The driving method of claim 9, wherein the scanning direction of the sub scan driver is a direction from a lower portion to an upper portion of the sub panel.
